(19) United States
(12) Patent Application Publication
(10) Pub. No.: US 2013/0081388 A1
(43) Pub. Date: Apr. 4, 2013

(54) WAVE POWERED BUOYANCY CONTROL SYSTEM FOR FLOATING WAVE POWER PLANTS

(71) Applicants: Ingvald Straume, Ottestad (NO); Arild Viste, Fana (NO)

(72) Inventors: Ingvald Straume, Ottestad (NO); Arild Viste, Fana (NO)

(73) Assignee: PURENCO AS, Bergen (NO)

(21) Appl. No.: 13/513,130

(22) PCT Filed: Nov. 19, 2010
(86) PCT No.: PCT/EP2010/067822

§ 371 Date: Dec. 19, 2012

(30) Foreign Application Priority Data
Dec. 1, 2009 (GB) 0921079.0

(51) Int. Cl. F03B 13/14

(52) U.S. Cl. CPC F03B 13/14
USPC 60/496

(57) ABSTRACT

A system for controlling the submersion of a floating section/body of a wave power plant includes a pump connected to a compressible fluid accumulator and a ballast chamber. The pump is arranged to pump compressible fluid from the ballast chamber to the accumulator. The system further includes an opening in a wall of the ballast chamber that enables the ballast chamber to let in seawater. Furthermore, the pump is powered by wave energy.

### CROSS-REFERENCE TO RELATED APPLICATION(S)

This application is a national stage application of PCT/EP2010/067822, filed on Nov. 19, 2010, entitled “Wave Powered Buoyancy Control System for Floating Wave Power Plants,” which claims priority to United Kingdom Patent Application No. 0921079.0, filed on Dec. 1, 2009. Both PCT/EP2010/067822 and United Kingdom Patent Application No. 0921079.0 are incorporated by reference herein in their entireties.

### BACKGROUND OF THE INVENTION

Experiences from the past decades and recent years of wave energy research have taught engineers that overload protection is an indispensable feature of any wave energy concept, if it is to have a chance of becoming commercially applicable.

The amount of energy contained in the most extreme waves is so immense that a wave energy converter must have some strategy to avoid a too high degree of interaction with those vast concentrations of energy. If not, the wave energy converter will be destroyed by the waves unless, of course, it is built so massive and oversized that it becomes unprofitable.

One proposed strategy to protect floating wave energy converters from the impact of extreme waves is to have them submerged during storm episodes. It is a commonly known fact that the motions of the waves are concentrated in the upper layers of the sea. As one moves deeper down into the water, the wave motions become smaller and less intense. Submersion of the installations in bad weather has repeatedly been suggested as an overload protection strategy, both for wave energy converters and offshore aquaculture facilities.

### SUMMARY OF THE INVENTION

In general, in one aspect, one or more embodiments of the invention are directed to a system and method for submerging floating wave energy converters and raising them to the surface, by using submarine buoyancy control technology powered by wave energy. The method has certain inherent characteristics which makes it self-regulatory without the use of computer technology or advanced control systems.

In general, in one aspect, one or more embodiments of the invention include a system and method for controlling the submersion of a floating section/body of a wave power plant in order to protect floating wave energy converters from the impact of extreme waves.

In general, in one aspect, one or more embodiments of the invention include a system for controlling the submersion of a floating section/body. The system includes a pump connected to a compressible fluid accumulator and a ballast chamber. The pump is arranged to pump compressible fluid from the ballast chamber to the accumulator. The system further includes an opening in the ballast chamber wall that enables the ballast chamber to let in seawater, and the pump is powered by the wave energy.

In accordance with one or more embodiments, the pump is arranged to be activated when the wave energy exceeds an energy threshold.

In general, in one aspect, one or more embodiments of the invention include a bypass passage with a flow resistance arranged between the compressible fluid accumulator and the ballast chamber.

In general, in one aspect, one or more embodiments of the invention include a ballast chamber with a seawater inlet/outlet that prevents compressible fluid from escaping out into the sea, by means of trapping the compressible fluid in a part of the ballast chamber which is at a higher vertical level than the sea water inlet/outlet.

In general, in one aspect, one or more embodiments of the invention include a part of the ballast chamber including the compressible fluid and a part containing sea water that may be separated by a flexible membrane.

In general, in one aspect, in accordance with one or more embodiments, the pump is activated when the instantaneous wave energy exceeds a threshold. In another embodiment, the pump may be activated when the accumulated wave energy exceeds a threshold.

In general, in one aspect, in accordance with one or more embodiments, the pump is powered directly by the movement of the floating section/body.

In general, in one aspect, in accordance with one or more embodiments, the system includes a hydraulic accumulator for storing wave energy absorbed by the wave power plant, and a safety passage leading from the accumulator to a hydraulic fluid reservoir, and the pump is powered by the flow in the safety passage.

In general, in one aspect, in accordance with one or more embodiments, the pump includes a piston with a piston crown disposed in a cylinder constituting a pump chamber defined by the piston crown and the cylinder walls, an inlet and an outlet for fluid, arranged so that fluid is drawn into the pump chamber through the inlet when the piston is stretched out of the pump chamber, and so that fluid is pressed out of the pump chamber through the outlet when the piston is pressed in, and a spring device exerting a tensile force on the pump working towards bringing the pump to its rest position with the greatest possible volume of the pump chamber.

In general, in one aspect, in accordance with one or more embodiments, the pump may be mounted inside two oppositely facing brackets which convert pressure forces acting on the pump to tensile forces, and vice versa.

In general, in one aspect, in accordance with one or more embodiments, the pump may be mounted on a lever which alters the force-amplitude ratio of the pump.

In general, in one aspect, in accordance with one or more embodiments, the pump is a rotation pump, where fluid is drawn from the pump's inlet and moved through the pump and pressed through the pump's outlet when the pump shaft rotates.

In general, in one aspect, in accordance with one or more embodiments, the flow resistance in the by-pass flow passage may be adapted to the pump capacity, by external regulation of the opening diameter of the flow resistance, by means of which the rate of flow from the accumulator through the by-pass flow passage is reduced when the diameter is reduced, and increased when the diameter is increased. The regulation may be performed by means of regulation means for changing the opening diameter of the flow resistance. The regulation/change of the opening diameter may be done before the system is placed in the water, or the passage may include a valve or other means that may be controlled when the system is in the water, for regulating the diameter of the opening of the flow resistance and thus regulating the flow of the flow passage.

In general, in one aspect, in accordance with one or more embodiments, the method for controlling the submersion of a floating section/body of a wave power plant includes activating, by wave power, a pump for pumping compressible fluid from a ballast chamber to a fluid accumulator when the intensity of the waves exceeds a certain level. The method further includes draining compressible fluid from the accumulator back into the ballast chamber through a by-pass flow passage, where seawater flows into or out of the ballast chamber through an inlet/outlet, in line with the rate of which the pump pumps compressible fluid into the accumulator and the rate of which compressible fluid is drained from the accumulator back into the ballast chamber through the by-pass flow passage.

### BRIEF DESCRIPTION OF THE DRAWINGS

In the following text the invention will be described in more detail by means of examples of embodiments and with reference to the accompanying figures. In the figures, similar items have the same reference numbers.

FIG. 1 shows one example of a variant of the compressor pump 1, namely a pressure-activated piston variant of the compressor pump in accordance with one or more embodiments.

FIG. 2 shows the same as FIG. 1, but with interior parts visible.

FIG. 3 shows one example of a stretch-activated piston compressor pump, where a pump like the one shown on FIGS. 1 and 2 is mounted inside an arrangement of two oppositely facing u-shaped brackets in accordance with one or more embodiments.

FIG. 4 shows the interior of a float, with the self-regulating buoyancy control system and its elements, in accordance with one or more embodiments.

FIG. 5 shows an example of how one or more embodiments of the invention may be integrated with a winch based wave energy converter, where the float is connected by wire to a wave energy absorbing winch system at the seabed.

FIG. 6a shows an example of the pressure-activated piston compressor pump integrated with a gear lever device in accordance with one or more embodiments.

FIG. 6b shows an alternate design of the lever bar 25 in accordance with one or more embodiments.

FIG. 7 shows an example of the stretch-activated piston compressor pump integrated with a gear lever device in accordance with one or more embodiments.

FIGS. 8-11 show examples of how one or more embodiments the invention may fit into different existing known floating wave energy converter devices, to improve the survivability of those technologies by providing to them a means for overload protection.

FIG. 8 shows how one or more embodiments of the invention may be integrated with the wave-driven ocean upwelling system from the company Atmocean, Inc.™ (http://www.atmocean.com).

FIG. 9 shows how one or more embodiments of the invention may be integrated with the “Pelagic Power 1” system, developed by the Norwegian company Pelagic Power AS (http://www.pelagicpower.no). This technology was launched in the sea near Trondheim for test trials, in 2007. At the time, it did not survive, due to extreme wave conditions, and lack of overload protection mechanism.

FIG. 10 shows how one or more embodiments of the invention may be integrated with the Pelamis Wave Energy Converter from the company Pelamis Wave Power, formerly Ocean Power Delivery (http://www.pelamiswave.com).

FIG. 11 shows how one or more embodiments of the invention may be integrated with the “Langlee E²” wave energy converter, from Langlee Wave Power AS (http://www.langlee.no).

FIG. 12 shows a part of an alternate embodiment of the invention, where the compressor pump 1 is integrated with a hydraulic power take of system of a kind which is already present in some wave energy converter systems.

### REFERENCE TERMS USED IN THE FIGURES

1. compressor pump

2. buoy (float) or floating section of wave power plant

3. wire

4. pump's inlet

5. pump's outlet

6. ballast chamber (ballast tank)

7. compressible fluid accumulator

8. seawater inlet/outlet

9. flow passage from ballast chamber to pump's inlet

10. flow passage from pump's outlet to accumulator

11. by-pass flow passage

12. hydraulic accumulator for smoothing captured energy

13. hydraulic power conversion pump

14. generator

15. hydraulic motor (turbine)

16. safety flow passage

17. hydraulic fluid reservoir

18. one-way valve

19. hydraulic motor (located in the safety flow passage)

20. top connection point for piston pump

21. bottom connection point for piston pump

22. upper u-shaped bracket

23. lower u-shaped bracket

24. spring-device

25. lever bar

26. mounting base for lever and compressor pump

27. attachment point at the end of the shorter segment of lever

28. shorter segment of lever

29. longer segment of lever

30. lever fulcrum shaft

31. connection face of mounting base

32. piston crown

33. membrane for separating compressible fluid from seawater in the ballast chamber

### DETAILED DESCRIPTION OF THE INVENTION

In embodiments of the invention, numerous specific details are set forth in order to provide a more thorough understanding of the invention. However, it will be apparent to one with ordinary skill in the art that the invention may be practiced without these specific details. In other instances, well-known features have not been described in detail to avoid obscuring the invention.

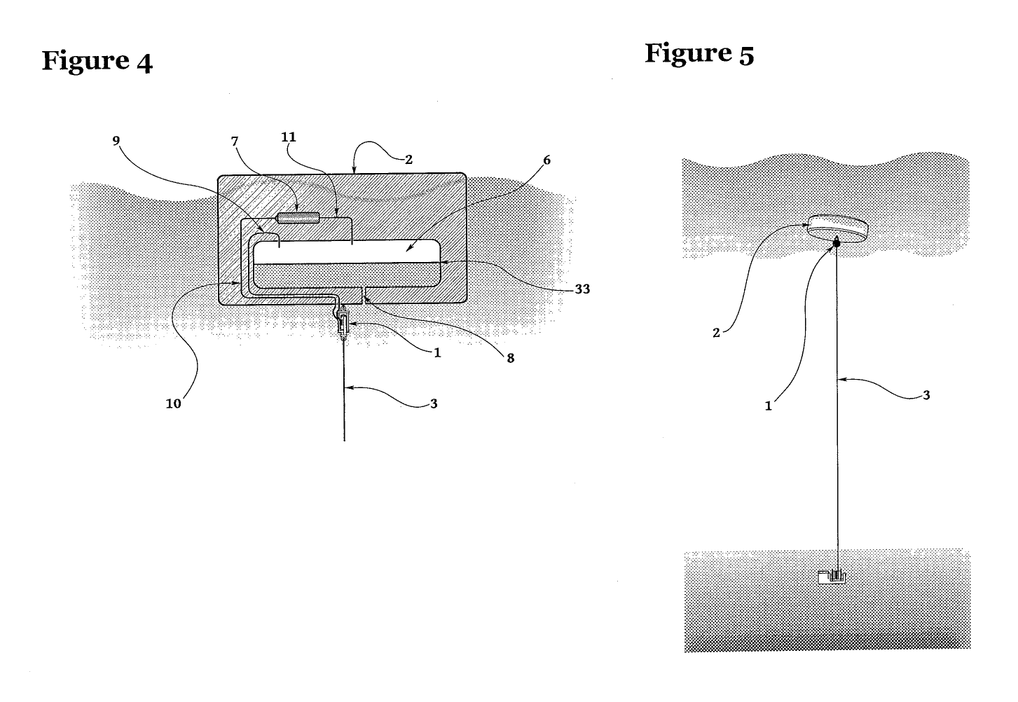

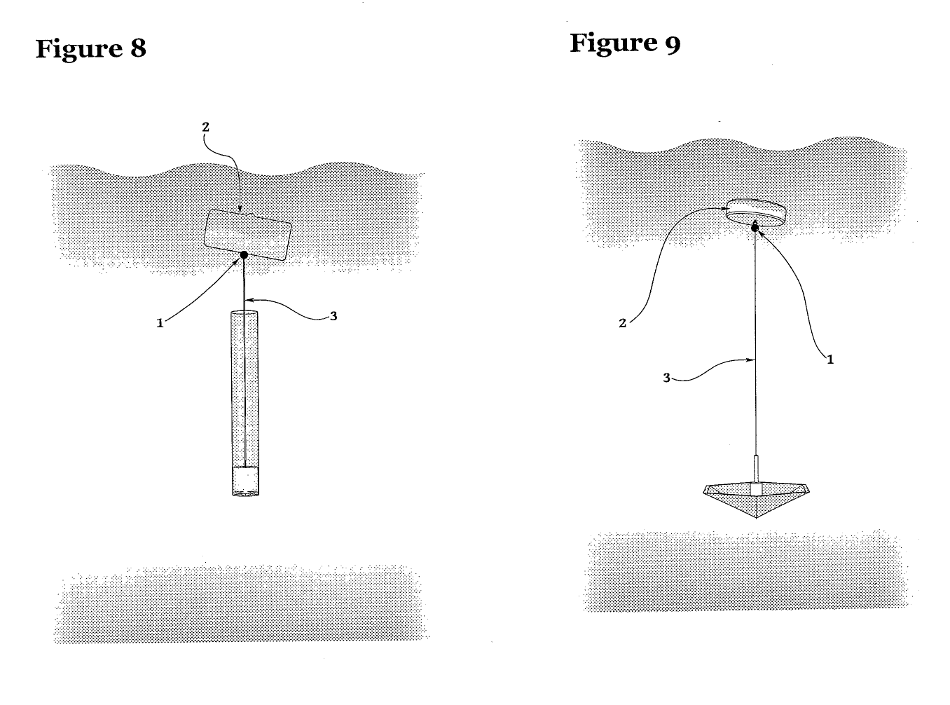

FIGS. 4, 5, 8, and 9 show a compressor pump 1 that is connected to a buoy, or a floating section 2, of a wave energy converter in accordance with one or more embodiments of the invention. The location of the compressor pump's connection may vary, depending on which kind of wave energy converter it is installed as a part of. A suitable location may be at a point in the structure where the flow of energy is high, or at a point where the mechanical forces which act from the waves upon the buoy, or the floating section, in extreme weather are particularly strong. For a wire anchored point absorber, like the ones shown on FIGS. 4, 5, 8 and 9, this location may be at the anchoring point between the float 2 and the wire 3.

The pump 1 is activated when the energy in the waves becomes excessive. This is because the pump system has a relatively high resistance against being activated mechanically. The pump must be acted upon by very strong forces in order to pump. In smaller waves, the pump is therefore idle. In order to design the system to make the pump start pumping in very large waves while being idle in small waves, the following parameters are particularly relevant: the volume of the accumulator 7 (which determines how fast the pressure increases in the accumulator as more compressible fluid is pumped into it), the initial pressure of the accumulator, the gear ratio (if the pump is connected to a gear), and the pump's displacement. The volume of the accumulator should be sufficiently small, or the initial pressure inside the accumulator should be sufficiently high, and the pump's displacement should be sufficiently high.

Throughout this document, the term ‘displacement’ of a hydraulic pump, refers to the pump's volume capacity, per revolution of the shaft of the pump or motor for a rotation pump, or per full pump stroke for a piston pump. The same understanding of the term applies for a hydraulic motor.

The pump's function is not to absorb and convert wave energy under normal operating conditions, i.e., in small and moderate sized waves. Instead, its function is to protect the wave power plant from suffering overload in very strong waves, by powering a self-acting and self-regulating submersion-system. This overload protecting submersion-system ensures that, in unfavourably big waves, the buoy or the floating section of the wave power plant is, at all times, just sufficiently submerged to avoid damaging impact from the excessively energy-intense wave motions near the surface.

In accordance with one or more embodiments, FIG. 4 shows that inside the buoy or floating section is a ballast chamber 6. This ballast chamber is filled with a compressible fluid, e.g., air, N2, or CO2. The ballast chamber is connected by a flow passage 9, as shown on FIG. 4, to the pump's inlet 4. The pump's outlet 5 is connected by a flow passage 10 to a compressible fluid accumulator 7. By means well known to fluid-mechanics engineers, the pump and its inlet and outlet are constructed so that fluid can flow through the pump 1 in one only direction: from the ballast chamber to the accumulator, and so that activation of the pump causes fluid to be pumped from the ballast chamber into the accumulator, thereby increasing the pressure inside the accumulator.

In accordance with one or more embodiments, FIG. 4 shows the bottom part of the ballast chamber has a seawater inlet/outlet 8, which is a relatively narrow passage leading from the ballast chamber to a small opening, which may be at the bottom side of the hull of the buoy or floating section, where sea water can seep into the ballast chamber. As a starting condition, the ballast chamber is completely filled with a compressible fluid that has the same pressure as the surrounding environment. Therefore, no seawater can seep into the chamber, because the space is already occupied by the compressible fluid, and there is nowhere for the compressible fluid to escape. However, when the pump 1 is activated by excessive energy from the waves, the pump takes compressible fluid away from the ballast chamber 6, and stores it in the accumulator 7, so that sea water from below can enter the ballast chamber through the seawater inlet 8, thereby replacing the volume of the removed compressible fluid. As a consequence, the net buoyancy of the buoy or floating structure is reduced, and the buoy or floating structure will lie deeper in the water. As long as the energy impact from the waves on the buoy or floating structure is strong enough, the pump will continue to move compressible fluid from the ballast chamber into the accumulator, thereby decreasing the buoyancy further. Eventually the buoy or floating structure will be completely submerged and sink to a level beneath the ocean surface where the waves are calm enough to bring the pump's activity to a halt.

In accordance with one or more embodiments, the functionality of the pump, described above, causes the buoy or floating section to submerge and descend in the water when the waves get sufficiently rough. What “sufficiently rough” in effect is may be predefined by the engineers of the particular wave power plant, by appropriately adapting the size and characteristics of the pump and the volume of the ballast chamber and the accumulator and other relevant parts and parameters of the system to each other.

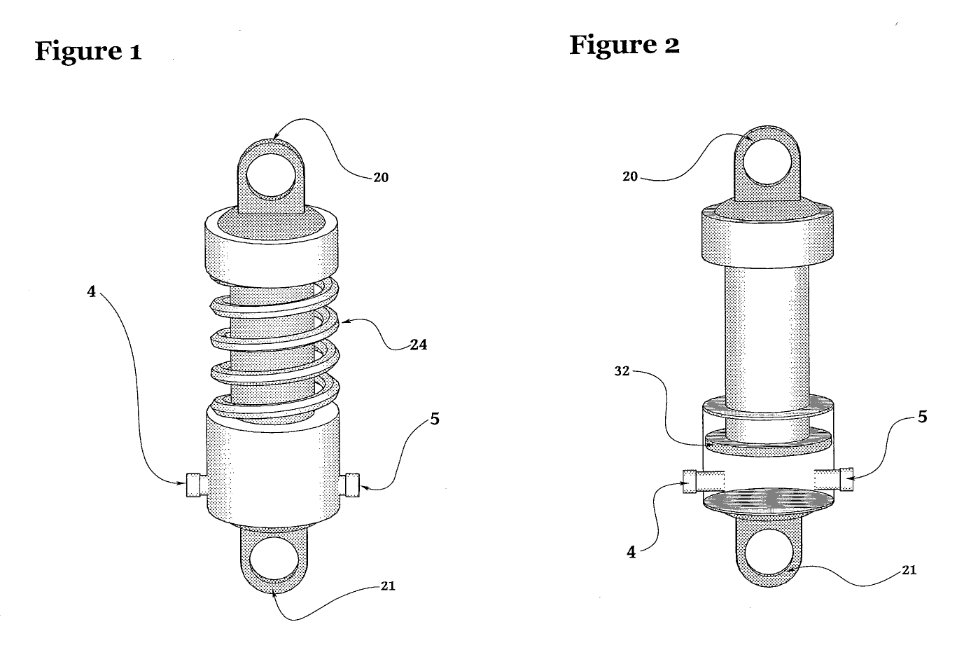

Possible designs for the compressor pump 1 may differ. In the embodiment referred to by FIG. 4, a piston pump, as shown on FIGS. 1, 2, 3, 4, 6a and 7, may be an appropriate choice.

The pump 1 may be described as a descending-agent. If the buoy or floating section had its buoyancy governed by the activity of said pump only, it would not be able to ascend in the water, and the pump would eventually cause it to sink to the bottom of the sea. Therefore, one or more embodiments of the overload protecting submersion-system described herein also include an ascending-agent, i.e., a device acting oppositely of the pump, increasing the buoyancy of the buoy or floating device. In accordance with one or more embodiments, the ascending-agent is a separate, narrow by-pass flow passage 11 from the accumulator 7 directly back into the ballast chamber 6. As long as the pressure in the accumulator is higher than the pressure in the ballast chamber, a small amount of compressible fluid will continuously escape through the by-pass flow passage back into the ballast chamber. The diameter of the by-pass flow passage may be adjusted to produce the desired rate of flow, to make the ascending-agent's work pace appropriately balance the work pace of the pump, to control and optimize the ascent-descent-behaviour of the system. A smaller diameter means that the process of ascending the buoy or floating section goes slower. A larger diameter means that the process goes faster. Having an accumulator 7 with a large volume, setting the initial pressure in the accumulator lower, and having a pump 1 with a high pump capacity, will make the process of descending the buoy or floating section go faster, and vice versa. All these parameters may be calibrated to control how fast or slow the buoy, or floating section, will ascend and descend in the water, and how high waves are needed to make it start submerging.

Also, it may be convenient to have an automatic flow-control-mechanism (e.g., a valve) which closes the by-pass flow passage when the pressure in the accumulator falls below a certain minimum pressure, this minimum pressure being higher than the pressure in the ballast chamber. Thus, it is ensured that the accumulator 7 will always hold a sufficiently high pressure, so that the pump 1 always will need a desired minimum force from the waves to be activated. This minimum pressure required for the by-pass flow passage's automatic flow-control-mechanism to open, is called the accumulator's initial pressure.

Those two counter-acting devices, the pump 1 which is the descending-agent, and the by-pass flow passage 11 which is the ascending-agent, together govern the buoyancy of the buoy, or floating section, of the wave power plant, so that the buoy, or floating section, if its parts and parameters are calibrated appropriately, at any time, in all wave conditions, will find itself at the optimum level of submersion with respect to overload protection and energy capture efficiency.

The cybernetic effect caused by these two counter-acting agents, the pump 1 and the by-pass flow passage 11, can be further explained by an example. In a given suddenly occurred sea state of rough waves, the buoy or floating section initially is located floating at the surface of the sea, where the wave energy impact is greatest. This great impact causes the pump 1 to be activated at high power. This again, causes compressible fluid to be pumped out of the ballast chamber 6 into the accumulator 7 at a much higher rate than the rate of which compressible fluid flows back into the ballast chamber from the accumulator through the by-pass flow passage 11. Consequently sea water enters through the inlet 8 and starts to fill the ballast chamber. Thereby, the buoyancy of the buoy or floating section decreases, and the buoy or floating section becomes submerged and starts to sink. As it continues to sink to lower levels in the pelagic zone, the energy impact from the waves onto the pump 1 is gradually lessened, and, thus, the pump's activity is gradually reduced. Eventually a state of equilibrium is reached, when the pump 1 and the by-pass flow passage 11 is working at equal pace. At that point, the buoy or floating section will stop sinking. Because if it sinks lower, the pump's working pace will continue to decrease past the equilibrium point, due to the lower impact of wave energy further down. Then, the amount of compressible fluid flowing back into the ballast chamber through the by-pass flow passage per time unit, will be greater than the amount of compressible fluid per time unit moved by the pump from the ballast chamber into to the accumulator, thereby increasing the buoyancy, causing the buoy or floating section to rise in the water, till it once again reaches the equilibrium point. As the waves calm down, the equilibrium point moves upward in the water. Thus, it is provided for that the buoy, or floating section, always finds itself at the most comfortable level of submersion, with regards to being with just the right amount wave energy: not too much energy, so the parts of the wave energy converter suffer overload, and not too little energy, so the energy capture is reduced. This ensures full operability of the wave power plant, even in the most severe storm episodes.

The ballast chamber 6 will alternately be filled with compressible fluid from the accumulator 7 and seawater. To prevent seawater from dissolving in the compressible fluid, and to make sure that no seawater enters the compressor pump/accumulator/ballast chamber circulation system, the ballast chamber can be separated into two parts by a flexible membrane 33, where the compressible fluid is trapped in the upper part above the membrane where the inlet of flow passage 9 and the outlet of flow passage 11 are, whilst the seawater is kept below the membrane.

### Alternate Embodiment

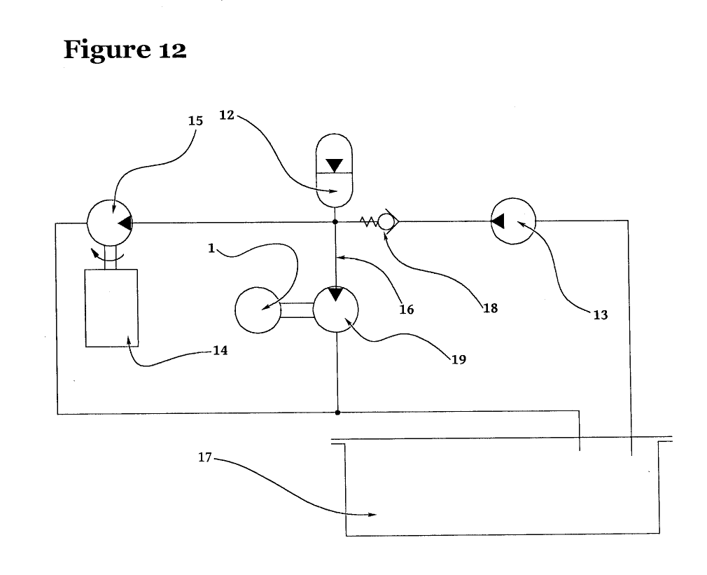

In an alternate embodiment of the invention, the pump 1 is mounted at a different location than described above: not at a point in the structure where the mechanical stress forces from the waves are expected to be greatest, like shown on FIGS. 5, 8, 9, 10 and 11. But at the location shown on FIG. 12. On FIG. 12, the ballast chamber 6, the accumulator 7, the flow passages 9, 10, 11 and the rest of the buoyancy-control system, except for the compressor pump 1, are not shown. Still, the alternate embodiment to which FIG. 12 refers, includes all those elements, with the same functions and arranged likewise as in the embodiments shown in FIGS. 4, 5, 8, 9, 10 and 11. This alternate embodiment may be applied if the wave energy converter has a hydraulic power take-off subsystem including a hydraulic accumulator 12 to temporarily store energy absorbed from the waves. FIG. 12 shows a general schematic drawing of such a system in accordance with one or more embodiments. Note that the hydraulic accumulator 12 on FIG. 12 is a different one than the accumulator 7: the hydraulic accumulator 12 is a common part of the power conversion system in many different types of wave energy converters. Rather, in accordance with one or more embodiments, the accumulator 7 is for storing compressible fluid from the ballast chamber 6, and is a part of the self-regulating buoyancy control system.

Power conversion using hydraulic means is the most prevalent choice in modern wave energy converters. In systems that use hydraulic power conversion, the first step of transfer, from mechanical to hydraulic energy, is performed by a pump 13, which typically is a linear piston pump. Other types of pumps, e.g., hose pumps, or rotation pumps (as exemplified in FIG. 12), are used in some systems. Companies whose technologies rely on hydraulic power conversion, include Pelamis Wave Power Ltd., Ocean Power Technologies, and Langlee Wave Power AS, among many others. To smooth the pulsating energy input from the wave energy absorbing pump 13, before the energy is transformed into electricity in a generator 14. Many of these wave energy technologies include a hydraulic accumulator 12, which temporarily stores the energy captured from the waves. From this accumulator, the energy is delivered to the generator through a hydraulic motor (turbine) 15, in the form of a smooth flow of hydraulic fluid under a steady high pressure. For safety reasons, the accumulator 12 is usually connected to a flow passage 16, which normally is closed, but where a safety valve can be opened, allowing hydraulic fluid to flow back into the low-pressure hydraulic fluid reservoir 17 bypassing the turbine 15, if the accumulator-pressure exceeds a certain level, to prevent the accumulator from exploding if something goes wrong (e.g., if the turbine wedges stuck or the turbine passage is blocked in one way or another).

One or more embodiments exploit this safety flow passage arrangement. Instead of a conventional safety valve, a hydraulic motor 19 is placed in the safety valve's position. This motor 19 has a relatively low displacement; i.e., a displacement which is significantly lower than the displacement of the hydraulic motor (turbine) 15. In practice, this low displacement means that the motor 19 behaves much like a safety valve. When the pressure inside the accumulator 12 gets too high, in rough waves, due to the hydraulic power conversion pump 13 working too diligently, delivering more hydraulic fluid—and thus more energy—to the accumulator 12 per time unit than the turbine 15 and the generator 14 can take off, the surplus of hydraulic fluid in the accumulator is dissipated through the safety flow passage 16, and led back to the fluid reservoir 17, powering the hydraulic motor 19 on the way. Now, the hydraulic motor 19 in turn powers the compressor pump 1, which starts to move compressible fluid from the ballast chamber 6, into the compressible fluid accumulator 7, as described earlier. The cybernetic process of submerging, descending, and ascending the buoy, or floating section, in the water takes place in the same manner as described earlier. Note that the compressor pump 1 in the embodiment corresponding to FIG. 12 is a rotation pump.

Further Description of the Compressor Pump

In accordance with one or more embodiments, the compressor pump 1 is a rotation pump, as referred to above, cf. FIG. 12, the pump may be any functioning rotation pump capable of moving a compressible fluid. Several principles are known for moving a compressible fluid powered by mechanical rotational energy as input. Many different standard types of rotation pumps exist. Any suitable rotation pump can be used.

In accordance with one or more embodiments, the compressor pump 1 is a piston pump that has two connection points: a top connection point 20 and a bottom connection point 21. The piston variant of the compressor pump may be designed in two basic ways.

It can either be a piston pump which is activated when exposed to a force that pushes the connection points 20 and 21 closer to each other, like shown on FIGS. 1 and 2.

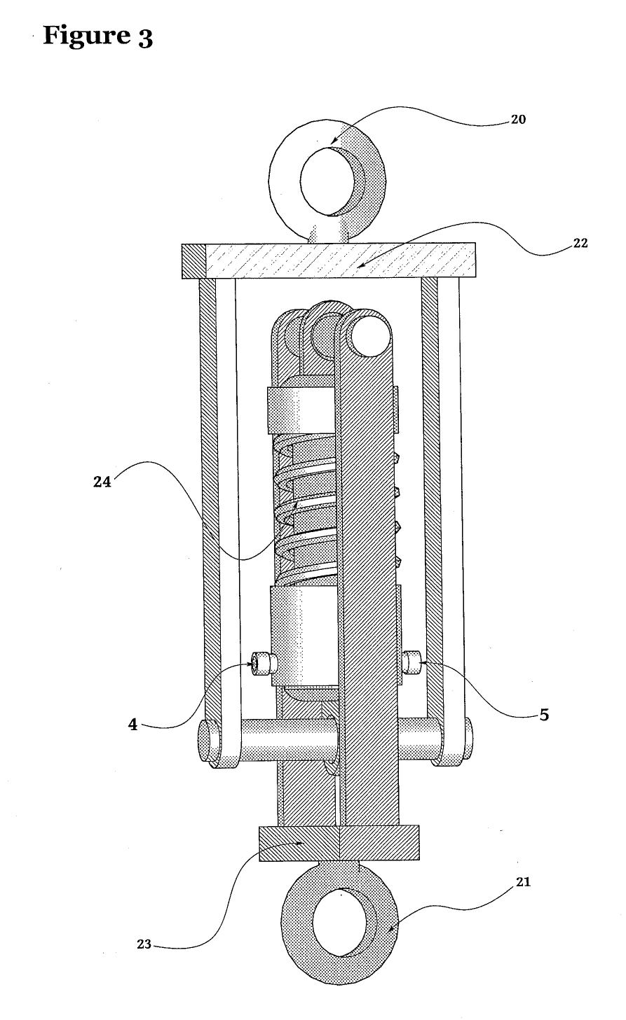

Another basic way of design, the piston pump may be activated when exposed to a force that pulls the connection points 20 and 21 farther apart. This latter variant may be achieved using a piston pump of the first type, cf. FIGS. 1 and 2, and mounting it into a frame of two oppositely facing u-shaped brackets 22 and 23, as shown on FIG. 3. This is a common method, known from mechanical engineering, to turn a mechanical pressure force into a stretch force, used with boat mooring springs, among other devices.

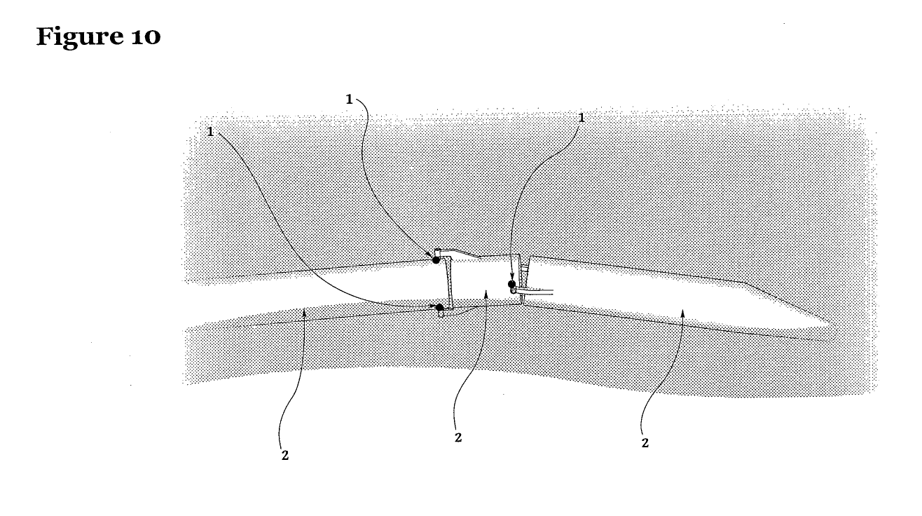

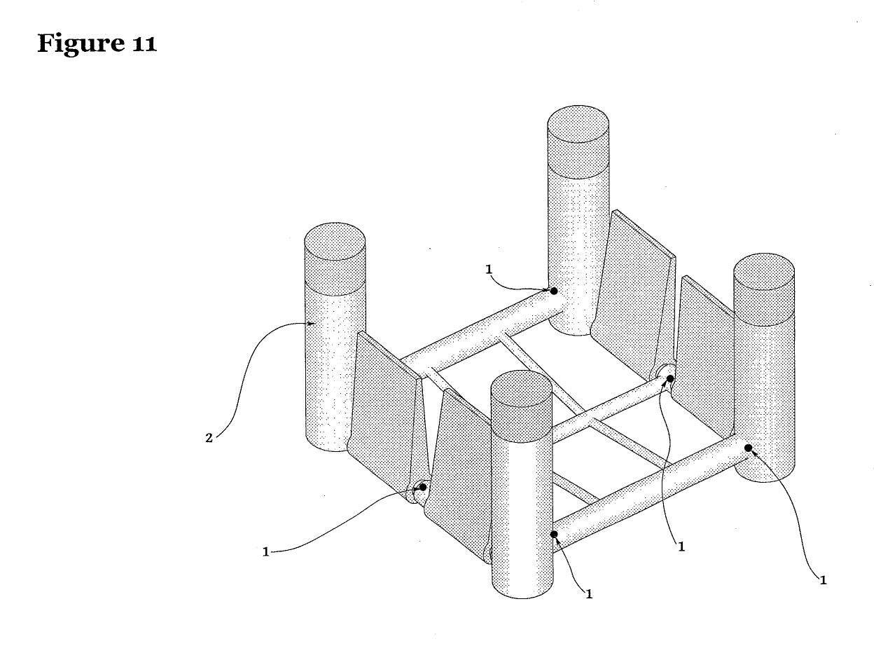

Which basic design of the piston pump should be used: the one that is activated when exposed to a pressure force, or the one that is activated when it is stretched, depends on which type of wave energy converter it is to be integrated with, and the location in which it is connected to the buoy or the floating section of the wave energy converter. On the wave energy converter devices depicted on FIGS. 5, 8 and 9, the stretch-activated design is the one to be used. On the ones depicted on FIGS. 10 and 11, either may be used.

The piston is returned to its rest position using a spring-device 24, which may be, but is not restricted to being, a mechanical spiral spring, like depicted on FIG. 1 (and also depicted on FIGS. 3, 6a and 7).

Gearing Down the Compressor Pump

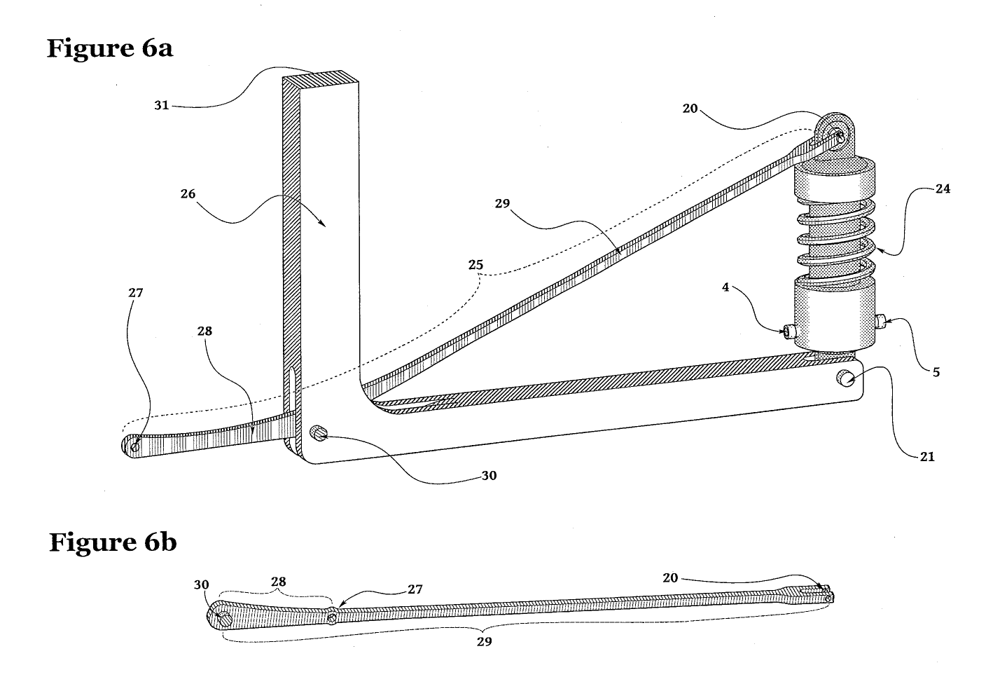

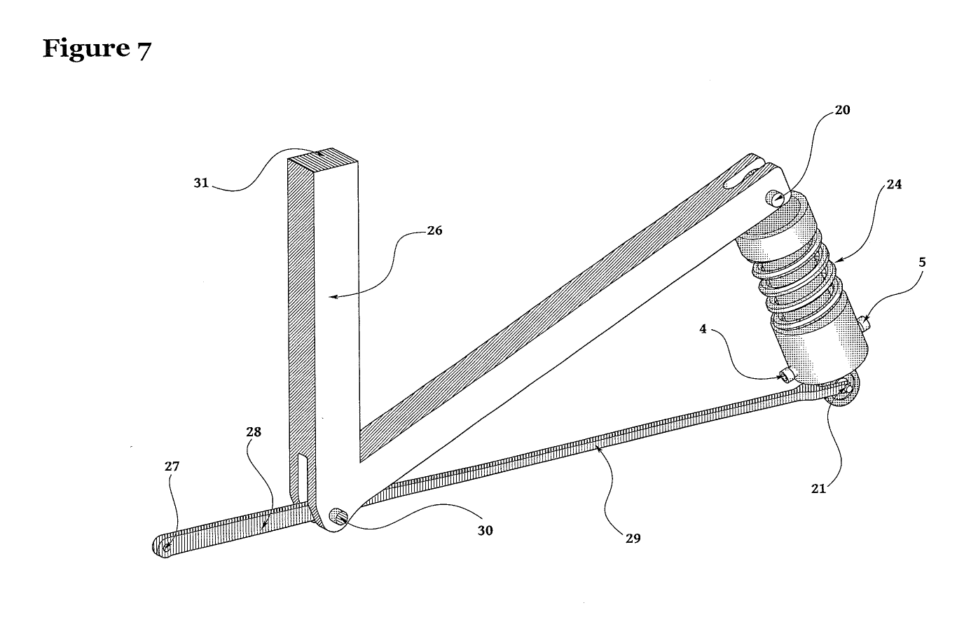

FIGS. 6a and 7 show the pressure-activated and stretch-activated variant of the piston pump, respectively, integrated with a gear device, using the lever principle.

Gearing down the compressor pump means that the pump piston cylinder and the piston crown 32 may have a smaller transverse diameter. It also means that the forces acting on the piston pump will be smaller, so the pump need not be so robust. This saves costs.

In accordance with one or more embodiments, the pressure-activated variant of the piston pump integrated with a gear device, can be achieved by having the lever bar 25 go through the mounting base 26, so that the attachment point 27 at the end of the shorter segment of the lever is on the opposite side of the attachment point 20 at the end of the longer segment of the lever, with respect to the mounting base, cf. FIG. 6a. (In this case, the attachment point at the end of the longer segment of the lever, coincides with the piston pump's top connection point 20.)

The stretch-activated variant of the piston pump integrated with a gear device, can be achieved by having both segments of the lever, the shorter segment 28, and the longer segment 29, on the same side of the mounting base, cf. FIG. 7. (In this case, the attachment point at the end of the longer segment of the lever coincides with the piston pump's bottom connection point 21.)

In accordance with one or more embodiments, on the upper side of the mounting base 26, is a connection face 31, which can be more extended than in the examples shown on FIGS. 6a and 7. The connection face 31 and the attachment point 27 are the two external connection points of the pump-lever device.

In the examples shown on FIGS. 6a and 7, the shorter segment of the lever and the longer segment of the lever are on opposite sides of the fulcrum shaft 30. Both variants of the pump-lever device can, however, be constructed using a lever bar which has the fulcrum shaft 30 at one end, and the end-attachment-point 20 of the longer segment at the other end. In this case, the shorter segment of the lever 28 is a sub-segment of the longer segment of the lever. And the length of the longer segment 29 is the total length of the lever bar. This variant of the lever is shown on FIG. 6b.

While the invention has been described with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

1. A system for controlling the submersion of a floating section/body of a wave power plant comprising:
a pump connected to a compressible fluid accumulator and a ballast chamber, wherein the pump is arranged to pump compressible fluid from the ballast chamber to the accumulator; and
an opening in the ballast chamber wall that enables the ballast chamber to let in seawater,
wherein the pump is powered by wave energy.

2. The system according to claim 1, wherein the pump is arranged to be activated when the wave energy exceeds an energy threshold.

3. The system according to claim 1, further comprising a bypass passage with a flow resistance arranged between the compressible fluid accumulator and the ballast chamber.

4. The system according to claim 1, wherein a design of the ballast chamber with a seawater inlet/outlet prevents compressible fluid from escaping out into the sea, by means of trapping the compressible fluid in a part of the ballast chamber which is at a higher vertical level than an opening of the sea water inlet/outlet.

5. The system according to claim 1, wherein a part of the ballast chamber including the compressible fluid and a part of the ballast chamber including sea water is separated by a flexible membrane.

6. The system according to claim 1, wherein the pump is activated when an instantaneous wave energy exceeds a threshold.

7. The system according to claim 1, wherein the pump is activated when an accumulated wave energy exceeds a threshold.

8. The system according to claim 1, wherein the pump is powered directly by the movement of the floating section/body.

9. The system according to claim 1, further comprising a hydraulic accumulator for storing wave energy absorbed by the wave power plant and a safety passage leading from the hydraulic accumulator to a hydraulic fluid reservoir and wherein the pump is powered by a flow in the safety passage.

10. The system according to claim 1, the pump further comprising:
a piston with a piston crown disposed in a cylinder constituting a pump chamber defined by the piston crown and the cylinder walls;
an inlet and an outlet for fluid, arranged so that fluid is drawn into the pump chamber through the inlet when the piston is stretched out of the pump chamber, and arranged so that fluid is pressed out of the pump chamber through the outlet when the piston is pressed in; and
a spring device configured to exert a tensile force on the pump working towards bringing the pump to a rest position with a greatest possible volume of the pump chamber.

11. The system according to claims 1, wherein the pump is mounted inside two oppositely facing brackets, which convert pressure forces acting on the pump to tensile forces, and vice versa.

12. The system according to claims 1, wherein the pump is mounted on a lever which alters the force-amplitude ratio of the pump.

13. The system according to claim 1, wherein the pump is a rotation pump, where fluid is drawn from an inlet of the pump and moved through the pump and pressed through an outlet of the pump when a shaft of the pump rotates.

14. The system according to claim, wherein the flow resistance in the by-pass flew passage is adapted to a pump capacity, by providing regulation means for changing the opening diameter of the flow resistance, wherein a rate of flow from the accumulator through the by-pass passage is reduced when the diameter is reduced, and increased when the diameter is increased.

15. A method for controlling the submersion of a floating section/body of a wave power plant, the method comprising:
activating, by wave power, a pump for pumping compressible fluid from a ballast chamber to a fluid accumulator when the intensity of the waves exceeds a certain level;
draining compressible fluid from the fluid accumulator back into the ballast chamber through a by-pass flow passage; and
flowing seawater into or out of the ballast chamber through an inlet/outlet, in line with the rate at which the pump pumps compressible fluid into the accumulator and the rate at which compressible fluid is drained from the accumulator back into the ballast chamber through the by-pass flow passage.

16. The system according to claim 2, wherein the pump is activated when an instantaneous wave energy exceeds a threshold.

17. The system according to claim 2, wherein the pump is activated when an accumulated wave energy exceeds a threshold.

18. The system according to claim 10, wherein the pump is mounted inside two oppositely facing brackets, which convert pressure forces acting on the pump to tensile forces, and vice versa.

19. The system according to claim 10, wherein the pump is mounted on a lever which alters the force-amplitude ratio of the pump.
